(19) United States
(12) Patent Application Publication
(10) Pub. No.: US 2008/0232610 A1
(43) Pub. Date: Sep. 25, 2008

(54) Audio Amplifier with Reduced Noises

(75) Inventor: Yung Keng Kung, HsinChu City (TW)

Correspondence Address: Tung & Associates, Suite 120, 838 W. Long Lake Road, Bloomfield Hills, MI, 48302, US

(73) Assignee: Chip Goal Electronics Corporation

(21) Appl. No.: 11/690,337

(22) Filed: Mar. 23, 2007

(51) Int. Cl. H04B 15/00

(52) U.S. Cl. 381/94.1; 381/94.5; 381/120

(57) ABSTRACT

An audio amplifier comprises: a first stage and a second stage amplifiers each respectively providing an output to a speaker; a first resistor electrically connected in parallel with the first stage amplifier; a second resistor electrically connected in series with an input of the first stage amplifier; a third resistor electrically connected in parallel with the second stage amplifier; a fourth resistor electrically connected in series with an input of the second stage amplifier, and also electrically connected in series with an output of the first stage amplifier; and a variable resistor electrically connected in parallel with the first resistor, the variable resistor and the first resistor forming a variable resistance parallel circuit.

### FIELD OF INVENTION

The present invention relates to an audio amplifier with reduced noises. The audio amplifier has low stand-by current, and there is no surge noise during power ON/OFF operation.

### DESCRIPTION OF RELATED ART

FIG. 1 is as chematic circuit diagram showing a typical structure of a conventional audio amplifier. As shown in the figure, the conventional audio amplifier employs two amplifiers 11, 12 connected in series to generate the required output power. However, due to different response time of the two amplifiers, as shown in FIG. 2, the electric potentials at the output terminals VOUT+ and VOUT− are not kept balanced during the power ON/OFF stage. The imbalance results in noises such that the speaker at the load terminal generates pops and clicks.

In view of the abovementioned drawback, as shown in FIG. 3, U.S. Pat. No. 5,642,074 proposes an improvement wherein a comparator 130 is provided. The comparator 130 generates a signal to close a switch 122 during the power ON stage, bypassing the resistor RF1, so that the electric potentials at the output terminals VOUT+ and VOUT− are kept balanced. In addition, the cited patent provides a stand-by control mechanism wherein when the audio amplifier is in the stand-by mode, a stand-by control signal 143 opens the switch 142 to reduce power consumption from the supply voltage V+ through resistors R3 and R4 to ground, and it also shuts down the amplifiers 11 and 12. FIG. 4 is another embodiment shown in the patent, which is a variation of FIG. 3 under the same spirit.

The same applicant of U.S. Pat. No. 5,642,074 also obtains U.S. Pat. Nos. 5,648,742; 5,703,529; 5,939,938 and 6,346,854 under the same or similar spirit, with similar circuit structures.

However, the above prior art circuits have not totally solved the issue of surge noises. More specifically, the gain of the first stage amplifier 11 is decided by the ratio of the resistors RF1 and RI1 (RF1/RI1). In integrated circuit applications, the gain is determined by a user, usually in the range from 1 to 10 (RF1/RI1=1˜10). It is only when the gain is 1 that the above prior art circuits result in a smooth waveform as shown in FIG. 5 without any noise, but not so when the gain is larger than 1. The reason is as follows. The above prior art circuits control the voltage VOUT− by the operation of the switch 122, such that the resistor RF1 is bypassed during the power ON stage; the gain of the first stage amplifier 11 is 1 (unity gain) at this stage. Thereafter, when the circuit enters the normal operation mode, the comparator 130 opens the switch 122, and the resistor RF1 becomes effective. At this stage, the gain of the first stage amplifier 11 is decided by the ratio RF1/RI1, and if the gain is a number other than 1, such as 5, the gain of the first stage amplifier 11 suddenly changes from 1 to 5 when the switch 122 switches OFF, which will generate surge noises as shown in FIG. 6. This will cause the speaker to generate noises, and the larger the gain is, the worse the noises are. In a portable headphone application, the issue is even worse.

Besides the above drawback, in the stand-by mode, there is still a power consumption path from the supply voltage V+ through resistors R5 and R6 to ground; moreover, the comparator 130 can not be shut down, or else the switch 122 will not be under accurate control. Hence when the audio amplifier is in the stand-by mode, its power consumption control is not optimum. As is well known, low power consumption is very important to portable products.

### SUMMARY

In view of the foregoing, it is desirous, and thus an object of the present invention, to provide an audio amplifier with reduced noises and low stand-by current which solves the issues in the prior art circuits.

In accordance with the foregoing and other aspects of the present invention, and as disclosed by one embodiment of the present invention, an audio amplifier comprises: a first stage and a second stage amplifiers each respectively providing an output to a speaker; a first resistor electrically connected in parallel with the first stage amplifier; a second resistor electrically connected in series with an input of the first stage amplifier; a third resistor electrically connected in parallel with the second stage amplifier; a fourth resistor electrically connected in series with an input of the second stage amplifier, and also electrically connected in series with an output of the first stage amplifier; and a variable resistor electrically connected in parallel with the first resistor, the variable resistor and the first resistor forming a variable resistance parallel circuit. The variable resistor has a resistance that is changeable among at least three states, i.e., three different resistances, and preferably, it has a resistance that is variable continuously. At the initial power ON stage, the variable resistor has a low resistance; when (at the same time or after) the supply voltage enters the normal operation mode, the resistance of the variable resistor increases so that the parallel circuit has a resistance that is approximately or substantially equal to the resistance of the first resistor.

In one preferred embodiment, the variable resistor includes a switch and a variable resistor device electrically connected in series. In one preferred embodiment, the audio amplifier further comprises a comparator, whose output is stored in a latch circuit, and the output of the latch circuit controls the switch. Thus, the comparator may be shut down during the stand-by mode. In one preferred embodiment, the output of the comparator is obtained from comparison between two signals: one of which is a dividend voltage of the supply voltage, and the other of which is another dividend voltage of the supply voltage plus a voltage across a capacitor.

It is to be understood that both the foregoing general description and the following detailed description are provided as examples, for illustration rather than limiting the scope of the invention.

### BRIEF DESCRIPTION OF THE DRAWINGS

These and other features, aspects, and advantages of the present invention will become better understood with reference to the following description, appended claims, and accompanying drawings where:

FIG. 1 is a schematic circuit diagram showing a typical structure of a conventional audio amplifier;

FIG. 2 is a waveform diagram showing the drawback of the conventional audio amplifier shown in FIG. 1;

FIGS. 3 and 4 are two circuit diagrams respectively showing two conventional audio amplifiers;

FIGS. 5 and 6 are two waveform diagrams showing the drawback of the conventional audio amplifiers shown in FIGS. 3 and 4;

FIGS. 7 and 8 are two circuit diagrams respectively showing two basic concepts according to the preferred embodiments of the present invention;

FIG. 9 is a circuit diagram showing another preferred embodiment of the present invention; and

FIG. 10 is a wave form diagram showing the relationship among the voltage Va, the voltage Vb, and the operation of switch 711.

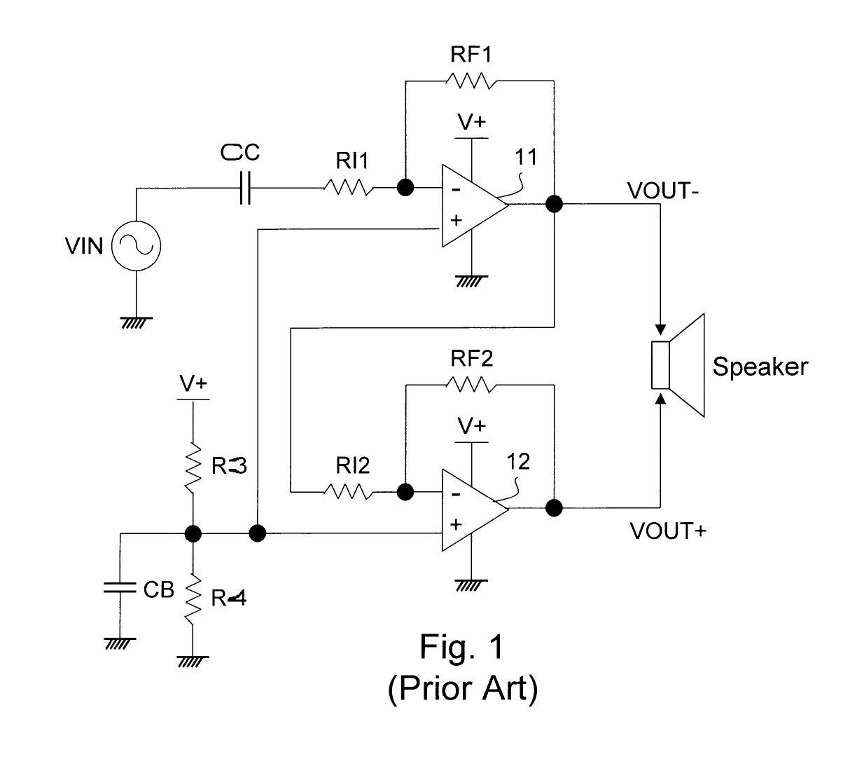

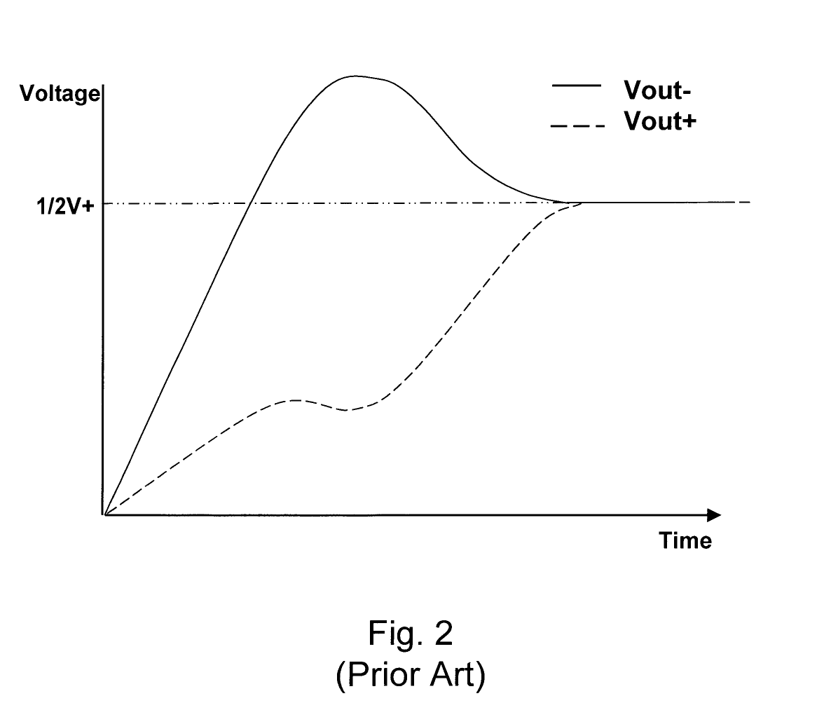

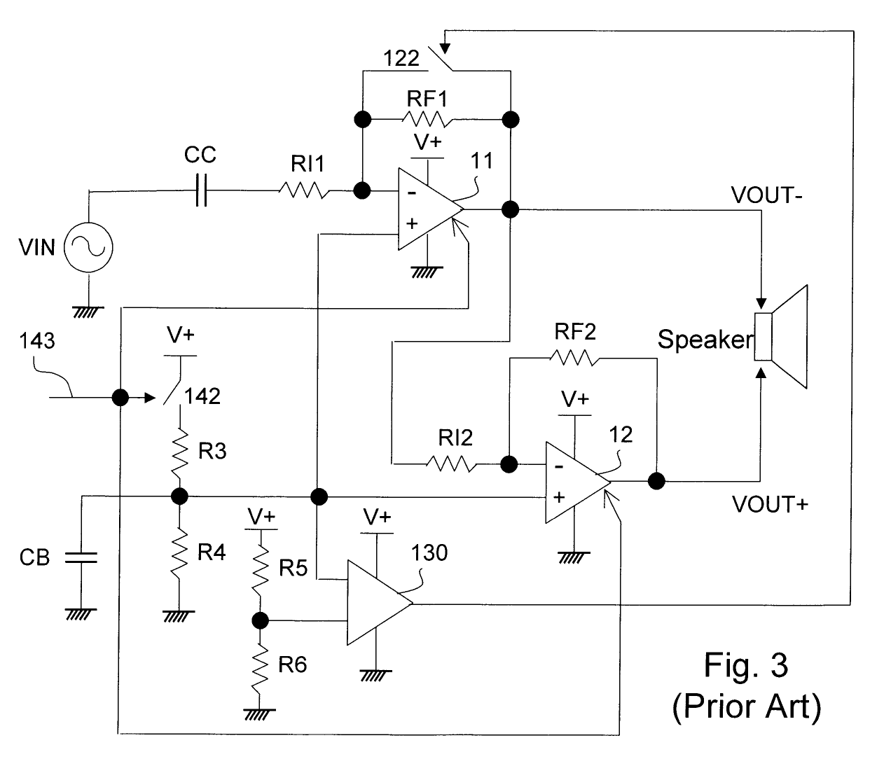

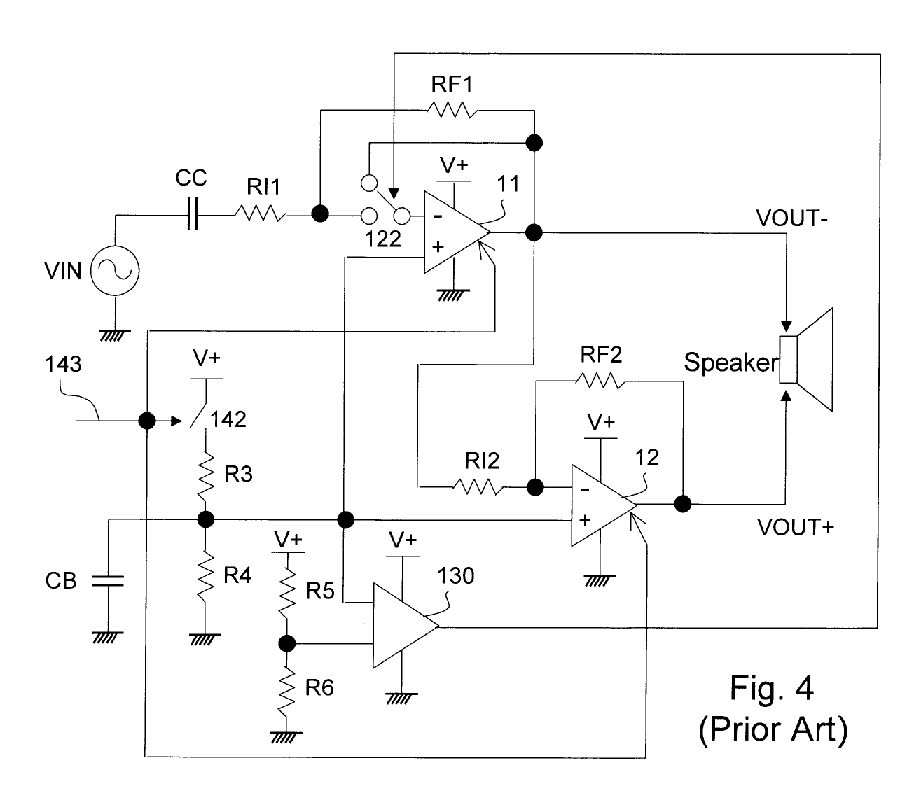

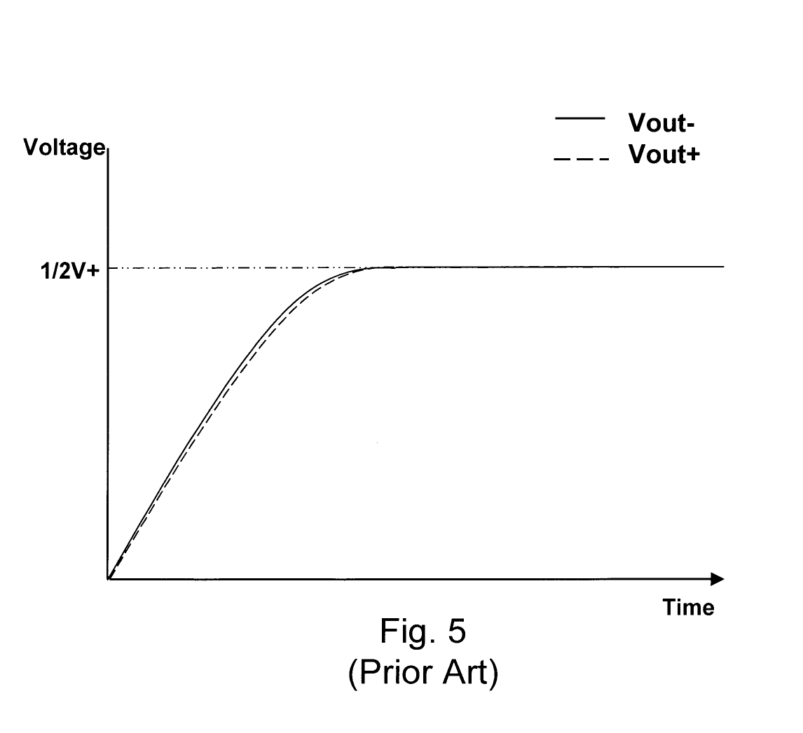

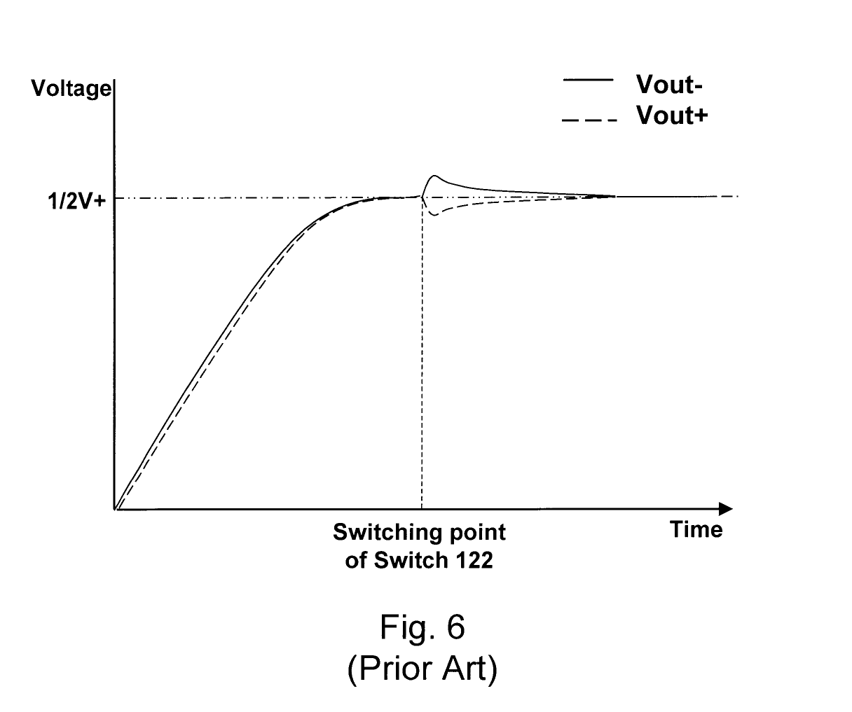

### DESCRIPTION OF THE PREFERRED EMBODIMENTS

The drawings as referred to throughout the description of the present invention are for illustration only, but not drawn according to actual scale.

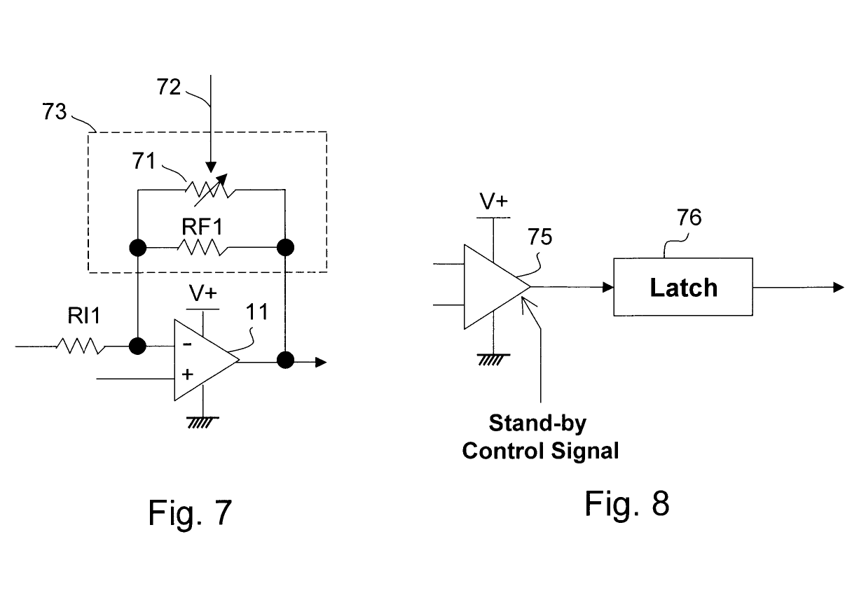

The present invention will first be explained with respect to its concept. Referring to FIG. 7, the first improvement made by this invention over the prior art is in its control of the gain of the first stage amplifier 11, so that the gain does not change suddenly. As shown in the figure, the switch 122 in the prior art is replaced by a variable resistor 71. The variable resistor 71 should be changeable among at least three resistances rather than only changeable between 0 and a fixed resistance, and preferably, the variable resistor 71 has a resistance that is variable continuously. The resistance of the variable resistor 71 is controlled by a control signal 72 so that, during power ON stage, the resistance of the variable resistor 71 gradually increases from 0 or a relatively lower value to a resistance that is far more greater than the resistance of the resistor RF1; in other words, the resistance of the parallel circuit 73 formed by the variable resistor 71 and the resistor RF1 gradually increases from a relatively lower value to a resistance that is approximately or substantially equal to the resistance of the resistor RF1. The gain of the first stage amplifier 11 equals to the resistance of the parallel circuit 73 divided by the resistance of the resistor RI1; therefore, the gradual increase of the resistance of the parallel circuit 73 indicates that the gain of the first stage amplifier 11 changes gradually, so that there is no noise generated.

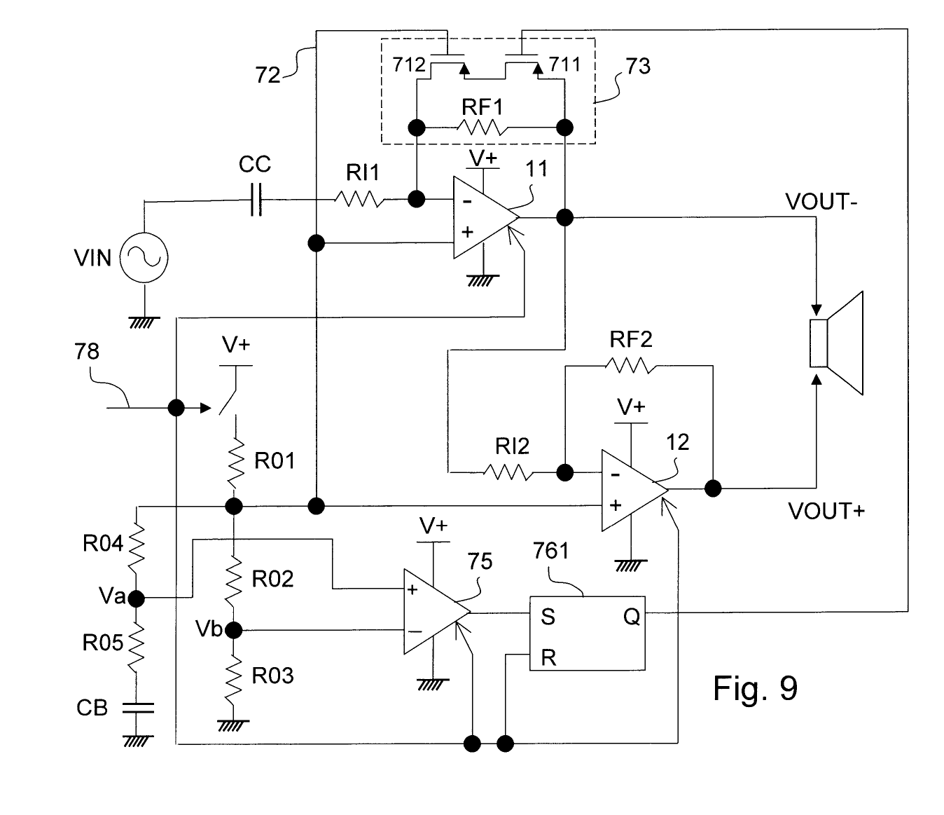

There are many ways to embody the variable resistor 71 and the control signal 72. One embodiment will be shown and explained in more detail with reference to FIG. 9.

Referring to FIG. 8, the second improvement made by this invention over the prior art is in its circuit structure relating to the comparator 130 (75 in the present invention), so that the comparator 75 may be shut down during the stand-by mode, and furthermore, it is no more required to keep a power consuming path for providing a reference voltage. As shown in the figure, the comparator 130 is replaced by a comparator 75 and a latch circuit 76; the latch circuit 76 latches the output from the comparator 75, so that the comparator 75 may be shut down during the stand-by mode, and the reference voltage providing to the comparator 75 may be shut down also.

FIG. 9 shows a preferred embodiment embodying the abovementioned concepts. However, it should be understood that what is shown is only an illustrative example of the audio amplifier according to the present invention; those skilled in this art may think of many other modifications and variations within the same spirit and scope.

In the embodiment shown in FIG. 9, in the parallel circuit 73 electrically connected in parallel with the first stage amplifier 11, there are a first path which includes the resistor RF1, and a second path electrically connected in parallel with the first path, which includes a switch 711 and a variable resistor device 712. The switch 711 and the variable resistor device 712 together construct the variable resistor 71 in FIG. 7. As shown in the figure, both the switch 711 and the variable resistor device 712 may be made of PMOS transistors, which is the simplest form to embody the switch 711 and the variable resistor device 712; however, other equivalents may be readily conceived by those skilled in this art, which still belong to the scope of the present invention.

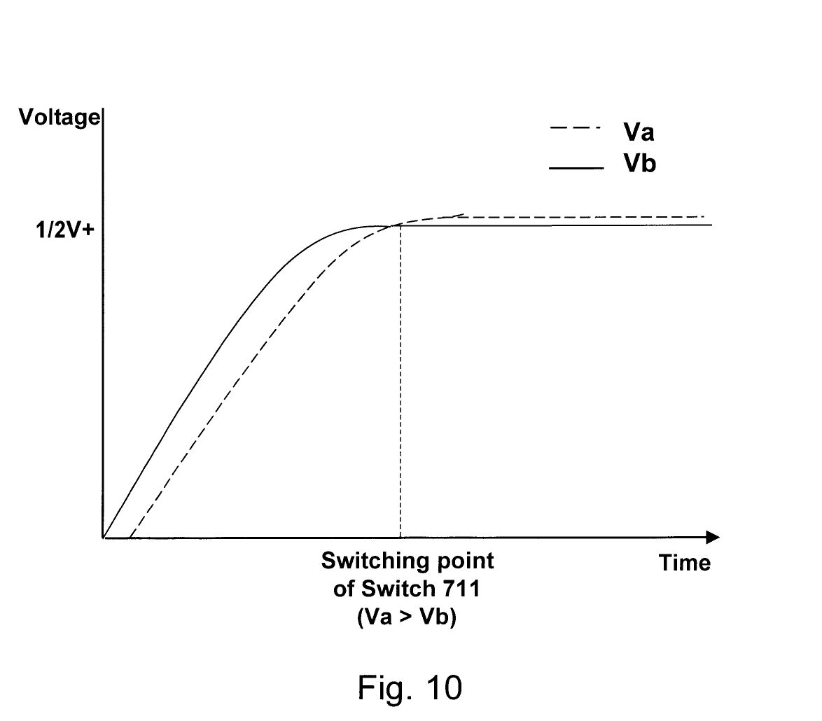

Now referring to the lower part of the figure, the output of the comparator 75 is sent to the setting terminal (S) of a flip-flop 761, to thereby latch the output of the comparator 75 in the flip-flop 761. The input voltages of the comparator 75 are Va and Vb, respectively; the voltage Va is a dividend voltage of the supply voltage V+, and the voltage Vb is another dividend voltage of the supply voltage V+ plus a voltage across a capacitor CB. By proper design of the resistances of the resistors R01-R05, and the capacitance of the capacitor CB, it may be arranged so that in the beginning of the power ON stage, the voltage Va is lower than the voltage Vb, but thereafter along with the charging of the capacitor CB, the voltage Va increases and finally crosses over the voltage Vb. Thus, the output of the comparator 75 changes its state, and the switch 711 is turned OFF. The relationships among the voltage Va, the voltage Vb and the operation of the switch 711 are shown in FIG. 10.

By proper design of the resistances of the resistors R01-R03, it may be arranged so that the resistance of the PMOS transistor 712 is far more greater than the resistance of the resistor RF1 when the gate voltage of the PMOS transistor 712 equals to (V+) (R02+R03)/(R01+R02+R03) (wherein V+ is the voltage value when the supply voltage is in normal operation). In other words, at the time point when the switch 711 switches OFF, the resistance of the parallel circuit 73 is near or equal to the resistance of the resistor RF1. Thus, when the switch 711 switches OFF, the gain of the first stage amplifier 11 does not change, or only changes slightly.

Moreover, please note that during the stand-by mode, the comparator 75 itself, and the signal generation paths for its input voltages Va and Vb, can all be shut down. As shown in the figure, the stand-by control signal 78 not only shuts down the comparator 75, but also shuts down the path from the supply voltage V+ to the resistors R01-R03, and the path from the supply voltage V+ to the resistors R01, R04, R05 and CB. Therefore, in comparison with the abovementioned prior art, the present invention further reduces unnecessary power consumption.

The spirit of the present invention has been explained in the foregoing with reference to its preferred embodiments, but it should be noted that the above is only for illustrative purpose, to help those skilled in this art to understand the present invention, not for limiting the scope of the present invention. Within the same spirit, various modifications and variations can be made by those skilled in this art. For example, the comparator 75 may be replaced by a hysteretic comparator; additional devices may be interposed between any two devices shown in the drawing, without affecting the primary function of the circuit; the devices for dividing the supply voltage are not necessarily resistors, but may be replaced by other devices such as various kinds of diodes, and so on. In view of the foregoing, it is intended that the present invention cover all such modifications and variations, which should interpreted to fall within the scope of the following claims and their equivalents.

What is claimed is:

1. An audio amplifier comprising:
a first stage and a second stage amplifiers each respectively providing an output to a speaker;
a first resistor electrically connected in parallel with the first stage amplifier;
a second resistor electrically connected in series with an input of the first stage amplifier;
a third resistor electrically connected in parallel with the second stage amplifier;
a fourth resistor electrically connected in series with an input of the second stage amplifier, and also electrically connected in series with an output of the first stage amplifier; and
a variable resistor electrically connected in parallel with the first resistor, the variable resistor and the first resistor forming a variable resistance parallel circuit; the variable resistor having a resistance that is changeable among at least three states.

2. The audio amplifier of claim 1, wherein the variable resistor has a resistance which is variable continuously.

3. The audio amplifier of claim 1, wherein the audio amplifier receives a supply voltage, and the resistance of the variable resistor is controlled by a first dividend voltage signal of the supply voltage.

4. The audio amplifier of claim 3, wherein when the supply voltage is in normal operation mode, the resistance of the variable resistor is larger than the resistance of the first resistor, so that the resistance of the parallel circuit is near or equal to the resistance of the first resistor.

5. The audio amplifier of claim 4, wherein the variable resistor includes a switch and a variable resistance device electrically connected in series.

6. The audio amplifier of claim 5, further comprising a comparator and a latch circuit, wherein the output of the comparator is stored in the latch circuit, and the output of the latch circuit controls the switch to turn the switch OFF when the supply voltage is in normal operation.

7. The audio amplifier of claim 6, wherein the comparator has two inputs, one of which is a second dividend voltage of the supply voltage, and the other of which is a third dividend voltage of the supply voltage plus a voltage across a capacitor.

8. The audio amplifier of claim 7, wherein the comparator is shut down during stand-by mode, and paths to supply the second dividend voltage and the third dividend voltage are also shut down.

9. The audio amplifier of claim 5, wherein the variable resistance device is a PMOS transistor whose gate is controlled by the first dividend voltage.
